(19) United States
(12) Patent Application Publication
(10) Pub. No.: US 2009/0279046 A1
(43) Pub. Date: Nov. 12, 2009

(54) ADJUSTABLE EYE GLASSES WITH A MAGNETIC ATTACHMENT

(76) Inventors: Andreas W. Dreher, Escondido, CA (US); Brett Spivey, Carlsbad, CA (US)

Correspondence Address: SCHWEGMAN, LUNDBERG & WOESSNER, P.A., P.O. BOX 2938, MINNEAPOLIS, MN, 55402, US

(21) Appl. No.: 12/464,411

(22) Filed: May 12, 2009

Related U.S. Application Data
(60) Provisional application No. 61/127,340, filed on May 12, 2008.
(60) Provisional application No. 61/127,350, filed on May 12, 2008.
(60) Provisional application No. 61/127,348, filed on May 12, 2008.
(60) Provisional application No. 61/127,341, filed on May 12, 2008.

(51) Int. Cl. G02C 7/08

(52) U.S. Cl. 351/55; 351/57

(57) ABSTRACT

In a particular embodiment, an eyeglass device is disclosed that includes a first frame member including a first frame member front that will often hold at least one corrective first lens and including a first end portion adapted to couple to a first temple. The eyeglass device further includes a second frame member having a second frame member front to hold at least one corrective second lens. The second frame member is adapted to associate with the first frame member via a magnetic coupling associated with the first end portion to secure a position of the at least one second corrective lens relative to the at least one first corrective lens to achieve a desired focal power.

### CROSS-REFERENCE TO RELATED APPLICATION(S)

This utility application claims priority from: U.S. Provisional Patent Application No. 61/127,340 filed on May 12, 2008 and entitled “MAGNETIC HINGE”; U.S. Provisional Patent Application No. 61/127,350 filed on May 12, 2008 and entitled “ADJUSTABLE EYEGLASSES FRAME”; U.S. Provisional Patent Application No. 61/127,348 filed on May 12, 2008 and entitled “ADJUSTABLE FOCUS EYEGLASSES FRAME WITH MAGNETIC BEARINGS;” and U.S. Provisional Patent Application No. 61/127,341 filed on May 12, 2008 and entitled “PRESS FIT LENS MOUNT,” each of which is incorporated herein by reference in its entirety.

### FIELD

This disclosure generally relates to adjustable eye glasses with a magnetic attachment, and more particularly to vision correcting eyeglasses that include first and second frame members that are associated with one another, at least in part, through one or more magnets.

### BACKGROUND

Eyeglasses can be used to correct a variety of vision problems, including near-sightedness, far-sightedness, and other vision problems. In some instances, eyeglasses can be configured to provide different focal powers at different angles. An example of such glasses can include frames having bifocal lenses (two different focal powers per lens) or trifocal lenses (three different focal powers per lens). However, such lenses provide different focal powers in discrete regions, which may cause the wearer to have to adjust his or her head and neck positions to utilize a particular discrete region of the glasses in order to view a particular object, such as text on a computer screen or a distant road sign. Such physical adjustments can lead to physical discomfort.

Adjustable focus lenses, including multi-component lens assemblies, such as two-component composite lens assemblies, where the lens elements translate in at least one direction relative to one another, have been described in other patents by one or both of the present inventors, including U.S. Pat. No. 7,338,159 issued to Spivey on Mar. 4, 2008 and U.S. Pat. No. 7,372,464 issued to Spivey on May 13, 2008. Further, adjustable focus eyeglasses were described in U.S. Pat. No. 7,325,922 issued to Spivey on Feb. 5, 2008. Each of these three patents is hereby incorporated herein by reference. These patents disclose techniques for designing adjustable focus lenses having two lens components that can be translated relative to one another to achieve a desired vision correction. However, to facilitate such translation, there is a need for adjustable frames to secure the lenses in desired positions. Accordingly, the present disclosure introduces new frame systems capable of securing such lenses, as well as other lens systems having two lens components.

### SUMMARY

The present invention includes frame assemblies for eyeglass, wherein the frame assemblies include two frame elements that are pivotably coupled to one another such that one may pivot relative to the other, and relative to an axis, and where the frames may be held in a desired relative position through one or more magnets. Each frame assembly is configured to hold one or more lenses, although in most embodiments, each frame assembly member will hold two lenses, to either provide vision correction for both eyes of a wearer, or vision correction for a single eye, and to provide a non-corrective lens for the other eye while providing an aesthetically pleasing appearance. Where correction is provided for only a single eye, the frame members may either support a pair of neutral lenses adjacent the other eye, or no lenses need be provided proximate that other eye. In another configuration, one frame may include no lenses, while the other frame may include a pair of lenses to provide one or more zones of correction, where the position of the correction in the wearer's field of vision may be changed by pivoting of the frame holding the lenses.

In a particular embodiments, the eyeglass device includes a first frame member configured to hold (at least) a first lens with a first configuration, and a second frame member to hold a second lens with a second configuration. In some embodiments the lens will be the part of a two-part composite lens assembly as discussed above, and as addressed in more detail later herein. In other embodiments, the lenses may merely be lenses that cooperate with one another to achieve a desired correction or magnification. Each frame member will include at least one (and preferably two) end portions. In many embodiments, the first and second frame members will couple to one another, at least in part, through attachment of the respective end portions, and the attachment will be, again, at least in part, through a magnetic coupling. The second frame member is pivotally adjustable relative to the first frame member, and is positioned to hold the first and second lenses one in front of the other, such that the first and second powers combine in the user's vision path to achieve a desired vision correction or magnification.

In another particular embodiment, an eyeglass device is disclosed that includes a first frame member having a first frame member front and having first and second end portions coupled to the first frame member front. The eyeglass device further includes a second frame member having a second frame member front including at least one lens rim to secure at least one optical lens. The optical lens has discrete regions with different focal powers. The second frame member further includes a third end portion coupled to the second frame member front and adapted to couple to the first end portion to secure the second frame member to the first frame member through a magnetic coupling. In a particular embodiment, the second frame member is adapted to rotate relative to the first frame member about an axis defined by the magnetic coupling to adjust an alignment of the optical lens to position a particular discrete region of the optical lens, offering a particular correction, at a desired position.

Other features of the present invention will be apparent from the accompanying drawings and from the detailed description that follows

### BRIEF DESCRIPTION OF THE DRAWINGS

The present invention is illustrated by way of example and not limitation in the figures of the accompanying drawings, in which like references indicate similar elements and in which:

FIG. 1 depicts a perspective view of a particular illustrative embodiment of an eyeglass device having a magnetic attachment.

FIG. 2 depicts a side view of the eyeglass device of FIG. 1.

FIG. 3 depicts a front view of the eyeglass device of FIG. 1 with end portions extended.

FIG. 4A depicts a top view in partial cross-section of an eyeglass device including a particular illustrative embodiment of a magnetic attachment having recessed areas of a first frame member adapted to receive posts of a second frame member.

FIG. 4B depicts a cross-sectional view of a second particular illustrative embodiment of a magnetic attachment including a recessed area of a first frame member adapted to receive a post of a second frame member.

FIG. 4C depicts a cross-sectional view of a third particular illustrative embodiment of a magnetic attachment including a post of a first frame member sized to fit a recessed area of a second frame member.

FIG. 5A depicts a side view of a particular illustrative embodiment of an eyeglass device including a first frame member having at least one first lens and including a second frame member magnetically attached to the first frame member and having at least one second lens aligned with the at least one first lens at an angle of zero degrees.

FIG. 5B depicts a side view of the eyeglass device of FIG. 5A illustrating the second frame member pivoted at an angle (B) relative to the first frame member.

FIG. 5C depicts a side view of the eyeglass device of FIG. 5A illustrating the second frame member pivoted at an angle (C) relative to the first frame member.

FIGS. 6A and 6B depict a second frame member of an eyeglass device, such as the eyeglass device illustrated in FIGS. 1-5C, in a front view, including slots corresponding to discontinuous rim portions of first and second rims, which first and second slots can be compressed or expanded to alter a shape dimension of the corresponding rims.

FIG. 7 depicts a flow diagram of a particular illustrative embodiment of a method of assembling an eyeglass device including a magnetic attachment.

FIG. 8 depicts a side view of an eyeglass similar to that of FIGS. 1-5C, but modified relative to the placement of the magnetic attachment.

FIG. 9 depicts an example of a two-piece composite lens assembly as may be used in some example of the glasses as described herein.

### DETAILED DESCRIPTION

The following detailed description refers to the accompanying drawings that depict various details of embodiments selected to show, by example, how the present invention may be practiced. The discussion herein addresses various examples of the inventive subject matter at least partially in reference to these drawings and describes the depicted embodiments in sufficient detail to enable those skilled in the art to practice the invention. However, many other embodiments may be utilized for practicing the inventive subject matter, and many structural and operational changes in addition to those alternatives specifically discussed herein may be made without departing from the scope of the invented subject matter.

In this description, references to “one embodiment” or “an embodiment” mean that the feature being referred to is, or may be, included in at least one embodiment of the invention. Separate references to “an embodiment” or “one embodiment” in this description are not intended to refer necessarily to the same embodiment; however, neither are such embodiments mutually exclusive, unless so stated or as will be readily apparent to those of ordinary skill in the art having the benefit of this disclosure. Thus, the present invention can include a variety of combinations and/or integrations of the embodiments described herein, as well as further embodiments as defined within the scope of all claims based on this disclosure, as well as all legal equivalents of such claims.

As identified earlier herein, some embodiments disclosed herein address an eyeglass device that includes a first frame member having a first set of rims to secure a first pair of lenses and a second frame member having a second set of rims to secure a second pair of lenses. For clarity, the following discussion refers to the first pair of lenses (in the first frame member) as “first” and “second” lenses and refers to the second pair of lenses (in the second frame member) as “third” and “fourth” lenses. In some embodiments, the first and third lenses are complementary, such that they form a first two-piece composite lens system to provide correction for one eye, while the second and fourth lenses cooperate to provide a second two-piece composite lens system to provide correction for the other eye. These composite lens systems offer a correction that is adjustable by displacing one lens of the system relative to the other lens in a direction that is substantially perpendicular to a Z-axis, (as used herein, “Z-axis” identifies an axis that extends perpendicular to a tangent to the outer surface of the first lens preferably along the line of sight of a person looking straight ahead (i.e., a straight gaze angle, such as through the first and third lenses)). As used herein, the term “substantially perpendicular” includes movement that is linear and along a plane within approximately 10 degrees or less of true perpendicular to the reference (Z) axis, and also includes movement along an arcuate path that intersects the reference axis and wherein the radius of the arcuate path is on the order of 15 mm or longer. The translation radius (of the arcuate lens path) will be measured from the pivot axis around which the lens translates to the center point of the “lens box” of the outer lens (i.e., the translating lens). As is known in the art, the “lens box” is the rectangle at the rear surface of the lens (as if the lens is sitting on a surface with the outer lens surface facing out), the rectangle having the dimensions defined by the distances between (i) the inner-most and outer-most extents of the lens, and (ii) the upper-most and lower-most extents of the lens. In some embodiments, radii as short as 10-30 mm may be used. However, in many designs, a radius of greater than 30 mm, such as from 30 to 50 mm may be desirable. In other configurations, because a longer radius more closely approximates linear movement, even longer radii may be used, such as up to 100 to even 150 mm. A radius longer than 150 mm will be hard to implement in most configurations for “everyday” glasses. In a particular embodiment, translation of the third lens is along an arcuate path intersecting the Z-axis to adjust a composite focal power of the first two-piece composite lens system. In this embodiment, the translation of the fourth lens will be along a similar arcuate path relative to the Z-axis of the other eye. This similar translation is accomplished through the pivoting relationship of the second frame member (holding the third and fourth lenses) relative to the first frame member, where the frame members hold their respective lenses of each composite lens system, in operative position relative to the other lens of the composite lens system. It should be noted that the description of the above example embodiment addresses primarily providing a desired composite focal power to correct the user's vision. It should be understood that other corrections may be accomplished through use of the two-piece composite lens system, such as corrections for astigmatism, and such corrections may be provided either alone or in combination with a focal power correction.

When the first, second, third, and fourth lenses are corrective (i.e., have a focal power that is not neutral), the first and third lenses and the second and fourth lenses can be designed to be complementary, such that the first and third lenses form a first two-piece lens system and the second and fourth lenses form a second two-piece lens system. The first and second two-piece lens systems may have different focal powers. Further, by translating the third and fourth lenses relative to the first and second lenses, the focal powers of the two-piece lens systems can be adjusted.

When combining lenses, a thickness (t) of the lenses can be determined according to the following equation:

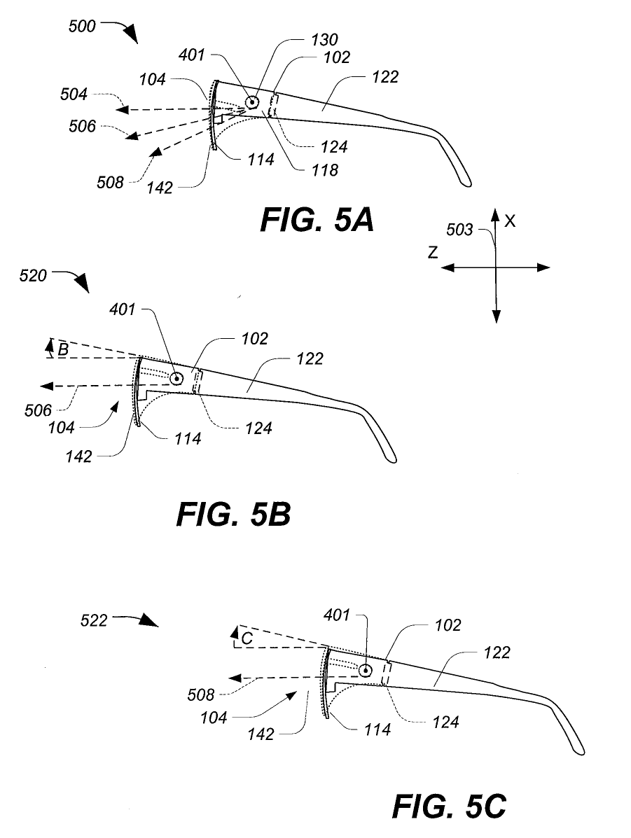

t=A(xy²+1/3x³)+Bx²+Cxy+Dx+E+F(y) (Equation 1)

where:
the variables (x and y) represent coordinates within an X-Y plane that is perpendicular to an optical axis (Z);
the variable (A) is a constant representative of a rate of lens power variation along the X-axis (depicted in FIG. 5A);
the variables B, C, D, and E are constants that may be given any practical value, including zero;
and the function (F(y)) is independent of the variable (x) and can also be zero. An example of an adjustable focus lens composite system that combines a focal power of two complementary lenses is described in U.S. Pat. Nos. 3,305,294 and 3,507,565, issued to Luis W. Alvarez in 1967 and 1970, respectively, which patents are incorporated herein by reference for all purposes.

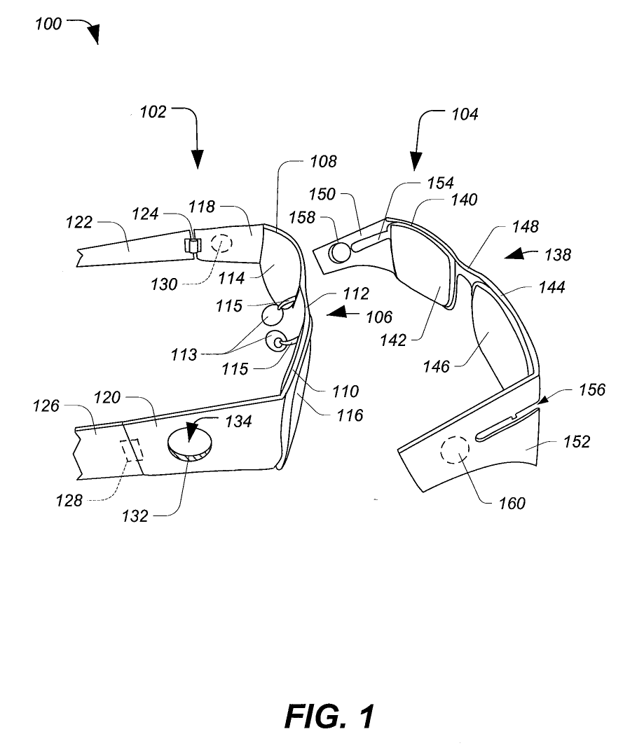

Referring now to FIGS. 1-3, therein are depicted perspective views of one example embodiment of an eyeglass device 100 having a magnetic attachment. The eyeglass device 100 includes a frame assembly including a first frame member 102 and a second frame member 104, which is adapted to couple to first frame member 102 through a magnetic coupling. First frame member 102 includes a front frame portion 106 having first and second rims 108 and 110 coupled to one another by a bridge 112. Bridge 112 includes nose pads 113 coupled to nose pad arms 115, which can be adjusted to improve fit and comfort for a particular user. Nose pads 113 and nose pad arms 115 form the nose pieces which in some frame designs could also be omitted or replaced by integrated nose pieces. The first and second rims 108 and 110 include first and second lenses 114 and 116, respectively, which can be secured in a conventional manner, such as through use of an adhesive, screws, nylon fibers, or any combination thereof.

First frame member 102 further includes first and second end portions 118 and 120, which extend from first and second rims 108 and 110; and also couple to first and second temples 122, 126 by first and second hinges 124, 128, respectively. Each of first and second hinges 124, 128 includes a first component coupled to a respective temple 122, 126; a second component coupled to a respective end portion 118, 120, and a pin or screw to secure the first and second components in pivotable relation to one another. First and second hinges 124, 128 allow first and second temples 122, 126 to articulate into a folded position relative to first frame member 102. Further, first and second end portions 122, 126 include first and second recesses 130, 132, respectively.

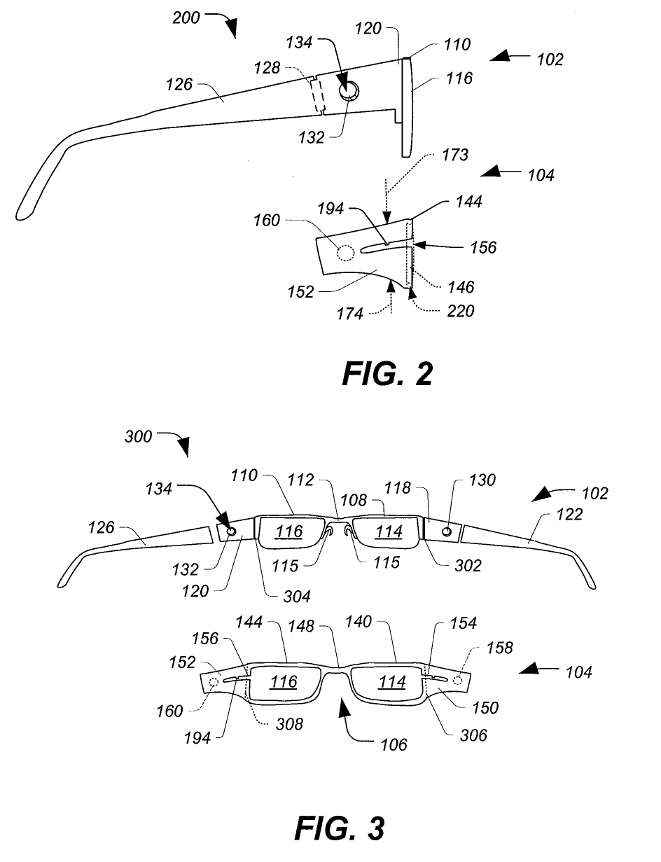

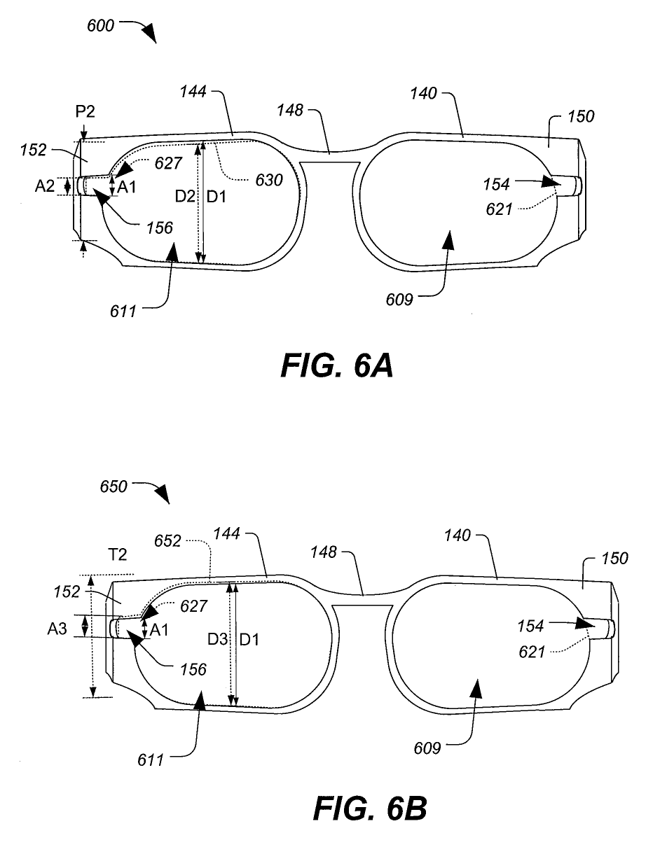

Second frame member 104 includes a second front frame portion 138 including third and fourth rims 140, 144, which are configured to retain third and fourth lenses 142, 146, respectively. Second front frame portion 138 further includes a bridge 148 that couples the third and fourth rims 140, 144, and further includes third and fourth end portions 150, 152, which extend from the third and fourth rims 140, 144, respectively. In this example, third and fourth end portions 150, 152 each includes a respective slot (or opening) 154, 156. Openings 154, 156 can be crimped or compressed to secure third and fourth lenses 142, 146 within the respective rims 140, 144. In particular, a compressive force may be applied to third and fourth end portions 150, 152 (as depicted in FIGS. 2 and 6A), compressing each slot 154, 156 and reducing the size of the lens-receiving openings of third and fourth rims 140, 144 to secure lenses 142, 146 therein. Third and fourth end portions 150, 152 each further include a post 158, 160, respectively. Posts 158, 160 are sized to engage recesses 130, 132 of the first frame member 102 by extending at least partially into a respective recess 130, 132. Posts 158, 160 and recesses 130, 132 may cooperate to form a magnetic coupling. In one example embodiment, posts 158, 160 will be formed from either a metal or a ferromagnetic material, and recesses 130, 132 will contain or be defined at least in part by magnets to attract the adjacent post 158, 160. In another example embodiment, posts 158, 160 will each include a magnet having a polarity that is opposite to the polarity of a magnet associated with the corresponding recess 130, 132. In another embodiment, posts 158, 160 may be sized to fit within recesses 130, 132, so as to form a frictional attachment to the respective end portion 118, 120. In still another embodiment, a magnetic coupling between the first and second frame members may be supplemented by such a frictional engagement between the posts 158, 160 and the surfaces defining recesses 130, 132 to assist the magnetic coupling in securing the second frame member 104 relative to the first frame member 102.

In some embodiments, the described magnetic or metallic material may be disposed in a bottom 134 of one or both of recesses 130, 132. In at least some such embodiments, a portion of posts 158, 160 will include a corresponding metallic or magnetic material, adapted to be magnetically attracted to the material at the bottom 134 of each recess 132, 130.

In another embodiment, one of recesses 130 or 132, and the corresponding post 158 or 160 will form a magnetic coupling, while the other post/recess combination will provide a mechanical attachment. In a particular example, the bottom 134 of the recess 132 may have a magnet placed therein, and the corresponding post 160 will include a metallic material that is magnetically attracted to the magnet. In this example, the other recess 130 does not include a magnet, and the post 158 is physically (but not magnetically) coupled to the recessed area, such as by relative sizing between the recess 130 and the post 158 configured to provide a high friction attachment of post 158 within recess 130.

In yet another particular example, post 158 may include a magnet and the recessed area 130 may include metallic material that is magnetically attracted to the magnetic post 158. In this example, post 160 may include metallic material and the bottom 134 of the recessed area 132 may include a magnet that attracts the metallic post 160. It should be understood that the magnetic coupling could also include opposite polarity magnets, such that post 158 may have a first magnetic polarity and recessed area 130 may have a second magnetic polarity, such that post 158 is magnetically attracted to the recessed area.

As noted above, In some embodiments, the pairs of first and third lenses 114, 142 and second and fourth lenses 116, 146 are components of a respective two-piece composite lens system providing adjustable correction through relative translation of the lenses. The described configurations for the first and second frame members 102, 104 function to facilitate that translation through an arcuate path. As described, second frame member 104 is configured to pivot relative to first frame member 102 around an axis defined by posts 158, 160. By pivoting the second frame member 104 relative to the first frame member 102, the second frame member 104 is translated relative to the first frame member along an arcuate path (as described earlier herein), and a focal power of each composite lens assembly of the eyeglass device 100 can be adjusted. In some embodiments, translation of third and fourth lenses 142, 146 relative to the first and second lenses 114, 116 along a similar arcuate path that is substantially perpendicular to a Z-direction will produce an adjusted focal power. In an alternative embodiment, where (for example) the second and fourth lenses 116, 146 are neutral (i.e., have little or no focal power), translation of fourth lens 146 relative to second lens 116 may not adjust a focal power of the second two-piece lens system. Additionally, where no correction is required for one eye, then no lenses need be provided proximate that eye. Also, in that case, the rims that would support the lenses may be substantially omitted, though it will often be useful to provide the inner portion of the rim supporting a nose arm 115, and nose pad 113 to assist in maintaining a desired placement of the entire frame on the user.

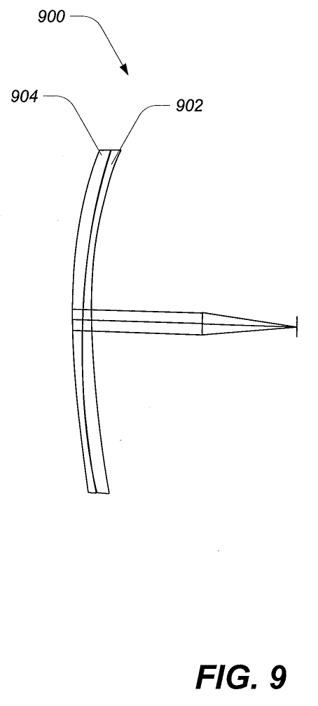

The specific configuration or design of the described pairs of lenses proximate each eye of a user is not a critical aspect of the present invention. Such pairs of lenses may be two-piece composite lens assemblies, as described, or may be independent lenses, where the placement of one lens primarily determines the placement of a correction. For example, in the case of a composite lens assembly having two components that cooperate to provide adjustable correction through their relative placement, in most cases, neither lens is intended to provide correction on its own. For example, as depicted in FIG. 9, the example lenses depicted are configured generally in accordance with the teachings of the Alvarez and Spivey patents referenced earlier herein, and do not exhibit surfaces that one might expect to be useful for any conventional vision correction, if used alone. However, the combination of both lenses does provide such correction. Such composite lens assemblies are distinguished from other lens pairs that may be used together, for example, lens pairs wherein at least one of the lenses does provide correction alone, and the other lens may be placed to provide supplemental correction or magnification, potentially in a specific location relative to the user's field of vision. One example of such a lens pair would include a single vision correction primary lens, with a supplemental lens to facilitate short range correction or magnification, where translation facilitates placing the supplemental lens effect within a selected portion of the user's field of vision, such as a lower portion of such field. The embodiments of frame assemblies discussed herein are useable with both composite lens assemblies and other two-piece, but non-composite, lens assemblies. Accordingly, the specific lens configuration for a given application may be of many types known to those skilled in the art.

As will be apparent to those skilled in the art, in addition to the composite lens assemblies referenced above, other configurations of composite lens assemblies are also known and could be used with the frames of the present invention. Additionally, the referenced Alvarez and Spivey patents specifically describe composite lenses that are adjustable through a linear translation along a single plane. Those skilled in the art will recognize from the teachings of the above patents, and also from the Spivey patent 7,325,922, that the ultimate configurations of the lenses represent a compromise among a large number of potentially variable parameters, and thus any practical composite lens design is the result of a number of design choices to balance these various parameters to arrive at a selective optimization. One additional such parameter that may be considered in such selective optimization is the relative movement of the two lens components of the composite lens system housed in a frame such as the above-described frame assembly, along an arcuate path, rather than along a linear plane. Composite lens assemblies designed for the lens components to be translated along a linear plane are believed to be useful with the frames as described herein. However, in at least some designs, it may be desirable for the composite lens assembly design to also consider such an arcuate path of translation, and potentially the dimensions of that path, within the balancing of the design parameters for the selective optimization of that specific lens design.

Referring now to FIG. 2, therein is depicted a side view 200 of the eyeglass device 100 of FIG. 1. Slot 156 is continuous with a lens-receiving opening defined by the rim 144. By applying a compressive force as indicated by lines 173 and 174, the area of the slot 156 may be reduced, altering at least one dimension associated with the lens receiving area. Further, the lens 146 may include a peripheral recess 220 that extends circumferentially about the edge of the lens 146 and that can mate with the rim 144 to secure the lens 146. Of course, additional security mechanisms, such as screws may also be used to maintain the slot in a desired spacing.

Further, in this particular example, a ridge 194 is visible within the slot 156. In an embodiment, the ridge 194 is sized to mate with a tool, such as a screw driver, to apply a lever force to the slot 156 via the ridge 194 to widen the slot 156 so that the lens 126 may be adjusted within the rim 144 or may be removed from the rim 144.

Referring to FIG. 3, therein is depicted a front view of certain frame assembly components 300 of eyeglass device 100 of FIG. 1, with first frame member 104, including temples 122 and 126 arrayed in a planar relationship. In an embodiment, the depicted components 300 of first and second frame members 102 and 104 can be stamped from a piece of sheet metal. Of course, the depicted layout is for explanation purposes only, and a more material-efficient layout of parts would be used in an actual stamping process. The stamped frames 102 and 104 may be bent along bend lines 302, 304, 306, and 308. In some embodiments, the sheet metal may be scored to form the bend lines 302, 304, 306, and 308. Where the forming is done from sheet metal, as described) posts 158, 160 can be secured to end portions 150, 152 at the post locations after the frame 104 is stamped.

After the first frame member 102 is stamped from sheet metal, the first and second temples 122 and 126 may be fixed to the first and second end portions 118, 120 by the hinges 124, 128. In some embodiments, temples 122, 126 may be formed from a different material than either or both of frames 102, 104. For example, temples 122, 126 could be formed from a plastic material or from a metal material other than sheet metal.

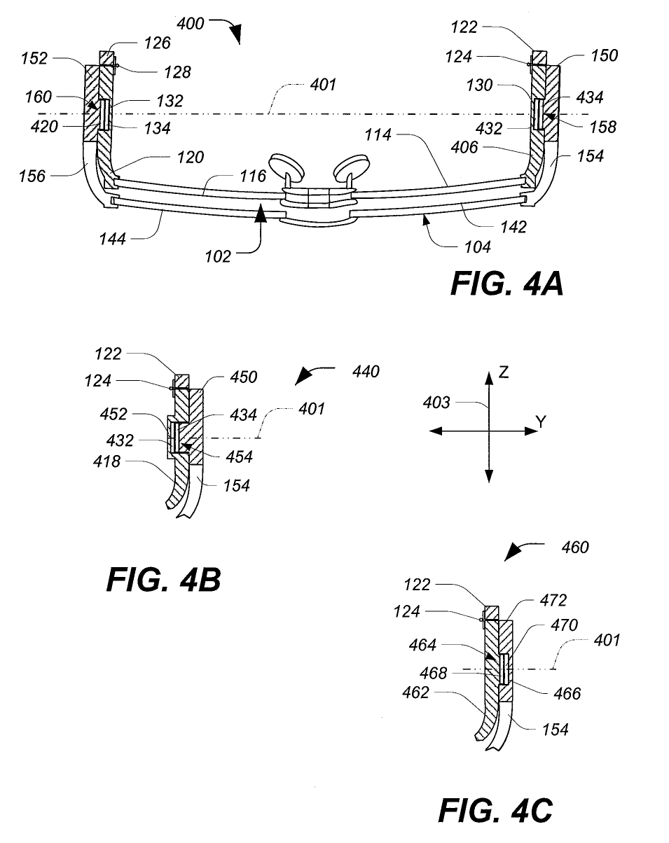

Referring now to FIG. 4A, therein is depicted a top view, illustrated in partial cross-section of a magnetic coupling for use with the eyeglass device 100 illustrated in FIG. 1. The cross-section is along a line that extends through the diameter of each coupling pivot 154 and 156. In this example, recessed areas 130, 132 include ferromagnetic or magnetic material 432, 134, respectively; and posts 158, 160 include corresponding magnetic or ferromagnetic material 434, 420, respectively. In an embodiment, posts 158, 160 and the corresponding recesses 130, 132 form magnetic couplings that define a pivot axis 401 about which second frame member 104 pivots relative to first frame member 102 to translate the lenses 142 and 144 relative to the lenses 114 and 116 along an arcuate axis as described earlier herein.

As noted above, the coupling between posts 158, 160 and the respective recesses 130, 132 may include both a frictional component and a magnetic component. In an embodiment, the magnetic coupling can cooperate with the friction between the respective recesses 130, 132 and posts 158, 160 to secure second frame member 104 at a desired translational position relative to first frame member 102. In this embodiment, the translational movement is essentially infinitely variable within a pertinent range of motion.

As illustrated below with respect to FIGS. 4B and 4C, other arrangements for the magnetic couplings are contemplated. For example, referring now to FIG. 4B, therein is depicted a cross-sectional view 440 of a second illustrative embodiment of a magnetic coupling for use with the eyeglass device 100 depicted in FIG. 1. In this instance, the recessed portion 452 may extend beyond a surface of the first end portion 418. In an embodiment, a magnet 432 is disposed within the recessed portion 452 and is adapted to attract a metallic portion (or a magnet of opposite polarity) 434 of the post 454. Alternatively, the recessed portion 452 may extend through the first end portion 418, and the magnet 432 may serve as the bottom of the recessed portion 452. In this example, the magnet 432 may be sufficiently wide to cover the opening of the recessed portion 452. In another embodiment, the magnet 432 and the metallic portion 434 of the post 454 may be interchanged.

In FIG. 4C, therein is illustrated a cross-sectional view of a third particular illustrative embodiment of a cross-sectional view 460 of a magnetic coupling for use with the eyeglass device 100 depicted in FIG. 1. In this example, the post is moved to the end portion of the first end portion 462, which may correspond to the first end portion 118 depicted in FIG. 1. In this instance, the first end portion 462 includes a post 464 having a ferromagnetic or magnetic material 468, which is selected to be attracted to a corresponding magnet or ferromagnetic material 470 of a recess 466 formed in an end portion 472 associated with the second frame member 104.

It should be understood that, in the embodiments of FIGS. 4A-4C, the posts 158, 454, and 464 can be cylindrically shaped and can be adapted to fit within a corresponding cylindrical recess 130, 452, and 466, which corresponding shapes facilitate rotational movement of the post within the recess. The rotational movement allows second frame member 104 to pivot relative to first frame member 102 about the axis 401 defined by the post and the recess to selectively translate the lenses substantially perpendicular to the Z-axis (as defined earlier herein). Such adjustments can be used to selectively move the retained lens elements, having any of the general conformities as discussed earlier herein to achieve a desired vision correction from eyeglass device 400. In at least some example corrections, the second frame member 104 can be translated relative to the first frame member 102 to translate the lens pairs relative to one another, allowing each two-piece composite lens unit to be adjusted by the user so that a viewed object at any distance from a few inches to infinity remains in focus over a wide distance.

One example configuration for an eyeglass device 100 may be with a first lens having a height of 36 mm, and a second lens having a height of 32 mm, and with each lens having a width of approximately 50 mm. Where the lens pairs are each a composite lens assembly as described earlier, this example will consider a composite lens assembly having a base power of approximately one (1) diopter and a variable power of plus or minus 1 diopter (±1), providing a maximum correction of up to 2 diopters. One example of a lens design, pursuant to a number of design choices balancing design parameters as discussed earlier herein, yields a lens pair wherein each lens has a minimum thickness of approximately 1 mm and an index of refraction of n=1.5. In this instance, the lens motion can be centered about an axis approximately 30 mm behind the lenses, causing a slight rotation in the Y-Z plane in addition to the translation. In this example, the pivot axis will allow translation of the lenses relative to one another with a minimum lens separation of 0.4 mm over a relative range of translational motion between the lenses of approximately 4 mm. The described lens pair can be produced with an average thickness of about 2.22 mm, a single-wavelength ray aberration diameter of less than 1.20 mrad at 0.5 radian off-axis look angles (corresponding to approximately a one-half (½) diopter of astigmatism), and a single-wavelength ray aberration diameter of less than 0.40 mrad at all 0.25 radian off-axis look angles (corresponding to approximately ⅙ diopter of astigmatism). It should be noted that the 30 mm pivot radius used in this example is only an example, and that the described composite lens systems can perform acceptably if the radius is within a range of about 10 or 15 mm to infinity (true linear translation), although a radius that is even shorter may be used in some instances. As a practical matter, the length of the radius will most often be restricted to a dimension shorter than the temples of the glasses, and in such cases will most often be less than an approximate practical maximum of 150 mm.

Referring now to FIGS. 5A-5C, therein is depicted a side view 500 of an embodiment of the eyeglass device 100 depicted in FIGS. 1-4C illustrating three different gaze angles 504, 506, and 508. An X-Z axis 503 is shown, where the Z-axis represents a gaze angle (or viewing direction). Second frame member 104 is adapted to pivot relative to first frame member 102 about a pivot axis 401. Side view 500 shows the eyeglass device 100 having a gaze angle 504 that corresponds to the viewing axis (the Z-axis). In this particular example, the third lens 142 is designed to complement the first lens 114 to provide a two-piece composite lens system having at least three discrete areas to provide a corresponding three focal powers. FIG. 5 depict the gaze angles in the context of a multi-component lens system. As will be apparent to those skilled in the art in view of prior disclosure herein, the depicted example may include a second pair of lenses forming a second two-piece composite lens system to correct vision in the other eye of a user, may include a different pair of lenses may or may not provide any correction, or that may provide one or more regions of correction that are selectively locatable within the user's filed of vision, or may not provide any lens proximate the other eye of the user. Where some degree of correction is provided for the other eye other than through a composite lens system, the lens pair may provide bifocal, trifocal, multifocal, or progressive addition-type lenses. With a conventional frame housing bifocal, trifocal, multifocal, or progressive addition lenses, the wearer typically has to gaze towards direction 504 to see distant objects, towards direction 506 to see intermediate distance objects, and towards direction 508 to see close objects. With this invention, by pivoting the second frame member, the wearer can achieve multiple focus positions without changing the gaze angle. Additionally, as noted earlier herein, in another configuration, one frame may include no lenses, while the other frame may include one lens or a pair of lenses to provide one or more zones of correction, where the position of the correction in the wearer's field of vision may be changed by pivoting of the frame holding the lenses. Again, for example, these lenses may include bifocal, trifocal, multifocal, or progressive addition-type lenses. The inner frame (which may or may not include rims), will provide support for the assembly on the user's face, and the translation of the position of the other frame will position the corrective portion of the retained lenses in a desired position in the user's field of vision.

As shown in FIGS. 5B and 5C, by adjusting the second frame member 104 relative to the first frame member 102, the third lens 142 is translated in an X-direction relative to the first lens 114 to selectively adjust the focal power of the two-piece lens system.

Referring specifically to FIG. 5B, therein is depicted a side view 520 of the eyeglass device 100 illustrating the second frame member 104 pivoted at an angle (B) relative to the first frame member 102 about the pivot axis 401. By pivoting the second frame member 104, the third lens 142 is translated relative to the first lens 114 to provide the intermediate distance view 506, which is moved into a straight gaze position (along the Z-axis).

Referring now to FIG. 5C, therein is depicted a side view 522 of the eyeglass device 100 illustrating the second frame member 104 pivoted at an angle (C) relative to the first frame member 102 about the pivot axis 401, translating the third lens 142 relative to the first lens 114 to provide the near distance view 508, which is moved into the straight gaze position (along the Z-axis).

It should be understood that the embodiments of FIGS. 5A-5C are provided for illustrative purposes only and are not intended to be limiting. For example, though three viewing angles 504, 506 and 508 are depicted, it should be understood that the two-piece composite lens system may be continuously adjusted over a range of values, rather than having a limited number of discrete focal areas. Further, it should be understood that the adjustments may achieve any number of focal powers. Further, it should be understood that the embodiments of FIGS. 5A-5C are not necessarily drawn to scale. For example, spacing between first lens 114 and third lens 142 illustrated in FIGS. 5B and 5C may increase as the second frame member 104 pivots. In many examples of such two-piece composite lens assemblies, such changing spacing between the lens components as the lens components translate is expected.

Referring to FIGS. 6A-6B, therein are depicted front views 600 and 650 of second frame member 104 illustrating deformable slots configured to alter a size and/or shape dimension associated with the rims. In the example of FIG. 6A, the second frame member 104 is made from a deformable material that retains a deformation after a pressure is applied. In the example of FIG. 6B, the second frame member 104 may be formed from a relatively elastic material that can be deformed by an applied tension or pressure and that returns to an original shape or size dimension after the tension or pressure is removed.

Referring now to FIG. 6A, therein is depicted a front view of a particular illustrative embodiment of the second frame member 600 of an eyeglass device, such as the eyeglass device 100 depicted in FIGS. 1-5C. Elements that are essentially the same as those of eyeglasses 100 of frame 150, have been numbered similarly. Second frame member 600 includes third and fourth rims 140, 144 coupled by a bridge portion 148. Third and fourth rims 140, 144 define lens receiving areas 609 and 611, respectively. Further, the third and fourth rims 140, 144 are continuous with third and fourth end portions 150, 152. In an embodiment, the slots 154, 156 can be deformable in response to an applied pressure or tension to selectively alter a shape dimension (such as a size dimension) of the first and second lens receiving areas 609, 611. It should be noted that for clarity of the depiction, slots 154, 156 are shown in significantly larger dimension relative to the remainder of second frame 148 than would be expected to be used. The specific size, shape and dimension of slots may be determined by a person skilled in the art in reference both to this disclosure and to the size, material and configuration of a particular frame configuration in question.

In this example embodiment, the second lens receiving area 611 has a first size dimension (D1) under normal pressure, such as atmospheric pressure. By applying a pressure (P2) on the third end portion 120, a height (A1) of second slot 126 is reduced to a second height (A2), deforming fourth rim 144 to an adjusted rim shape 630 that can have a second size dimension (D2), which is reduced relative to the first size dimension (D1). In this example, reducing the size dimension to the second size dimension D2 will cause fourth rim 144 to apply a compressive force (such as a hoop stress) or circumferential pressure on circumferential edges of a lens, securing the lens within the fourth rim 144. Similarly, pressure may be applied to third rim 140 to deform a shape dimension or a size dimension of the first lens receiving area 609 to secure a lens.

In the described embodiment, the applied pressure can cause the height (A) of slots 154, 156 to enlarge, which can change a height dimension of the rims 140 and 144. In this example, third and fourth rims 140, 144, third and fourth end portions 154, 156, or any combination thereof may be formed from a deformable material that can be deformed by stresses without destroying the structure of the frame 104. In this instance, the deformable material can be a metal, a plastic, or another material that can be deformed through the application of pressure, and that retains its deformed shape. In an embodiment, the second frame member 104 can be stamped from a sheet metal material and bent along a fold line associated with the end portions 150 and 152.

Referring now to FIG. 6B, therein is depicted a front view of an alternate embodiment of a frame 650 of an eyeglass device. Again, elements that are essentially the same as those of eyeglasses 100 of frame 150, have been numbered similarly. Frame 650 may be formed from a relatively elastic material, such as a molded plastic. In an example, the molded plastic may include glass fibers to make frame 650 substantially rigid.

In this example, the second lens receiving area 611 has a first size dimension (D1) under ambient conditions, such as atmospheric pressure. By applying a tension (T2) on the fourth end portion 152, a height (A1) of second slot 156 can be increased to a third height (A3), deforming the fourth rim 144 to an adjusted rim shape 652 that can have a third size dimension (D3) that is increased relative to the first size dimension (D1). In this example, second lens receiving area 611 can be increased to facilitate insertion of a lens. In this particular example, frame 104 may be formed from an elastic material that is deformable but that returns to an original shape after removal of tension or a pressure. For example, fourth rim 144 may deform in response to the applied tension (T2) as the slot 156 deforms. After the applied tension (T2) is removed, the fourth rim 144 will then start to return to its original shape, stopping when fourth rim 144 contacts the circumferential edges of the lens, thereby applying a compressive force on the edges of the lens to secure the lens within the second lens receiving area 611

In an example, an applied tension can alter a height of the slots 154, 156 and can thus change an associated height dimension of the rims 140, 144. When rims 140 and 144 are formed from deformable material, rims 140, 144 may retain an altered shape and/or size dimension when the tension is removed. When rims 140, 144 are formed from an elastic material, rims 140, 144 may return to an original shape or to a shape that is substantially similar to the original shape. It should be understood that the term “substantially” in the context of this particular frame 104 formed from elastic material refers to the possibility that the shape of lenses positioned within the first and second lens receiving areas 609, 611 may prevent third and fourth rims 140, 144 from returning to their original sizes and shapes.

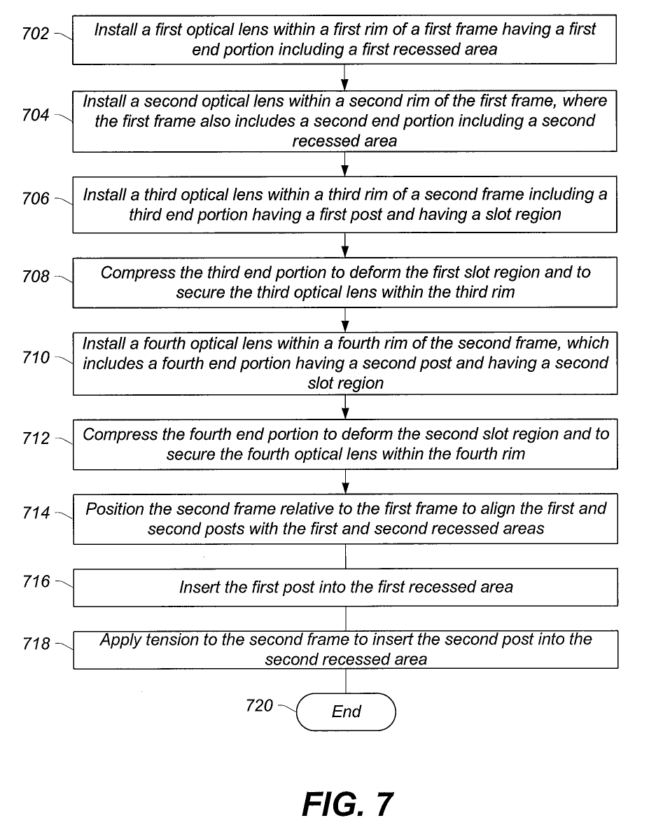

Referring to FIG. 7, therein is depicted a flow diagram of a particular illustrative embodiment of a method of assembling an eyeglass device including a magnetic attachment. At 702, a first optical lens is installed within a first rim of a first frame member having a first end portion including a first recessed area. Continuing to 704, a second optical lens is installed within a second rim of the first frame member, where the first frame member also includes a second end portion including a second recessed area. In a particular embodiment the first and second optical lenses may be glued, screwed, threaded, or otherwise attached to the first and second rims. In a particular example, nylon threads are used to fasten the first and second lenses to the first and second rims.

Moving to 706, a third optical lens is installed within a third rim of a second frame member including a third end portion having a first post and having a slot region. Continuing to 708, the third end portion is compressed to deform the first slot region and to secure the third optical lens within the third rim. In a particular example, by compressing the third slot region, a shape of the third rim is altered to apply a force around a circumferential edge of the third optical lens to hold the third optical lens in place.

Proceeding to 710, a fourth optical lens is installed within a fourth rim of the second frame member, which includes a fourth end portion having a second post and having a second slot region. Advancing to 712, the fourth end portion is compressed to deform the second slot region and to secure the fourth optical lens within the fourth rim. Continuing to 714, the second frame member is positioned relative to the first frame member to align the first and second posts with the first and second recessed areas, respectively. Moving to 716, the first post is inserted into the first recessed area. Advancing to 718, tension is applied to the second frame member to insert the second post into the second recessed area. The method terminates at 720.

In a particular embodiment, the first and second posts and the first and second recessed areas include magnetic portions and metallic portions or magnetic portions of opposite polarities to attract one another. Further, the magnetic portions operate to secure the second frame member relative to the first frame member. In a particular embodiment, the first and second posts and the first and second recessed areas cooperate to define magnetic couplings about which the second frame member is adapted to pivot to selectively adjust a focal power of the eyeglass device.

It should be understood that the order of the blocks in FIG. 7 is illustrative only, and is not intended to be limiting. Further, the particular blocks may be rearranged or combined without departing from the spirit and the scope of this disclosure. For example, blocks 706, 708, 710, and 712 may be performed before block 702. Further, blocks 706 and 710 and blocks 708 and 712 may be combined into single steps. Similarly, blocks 702 and 704 may be combined.

Additionally, depending on the implementation, the installation of the posts into the recessed areas may include additional steps, such as gluing a magnet within the recess or onto the post and gluing a corresponding metallic material onto the post or within the recess. Further, depending on the embodiment, the post may be part of the first or second frame member and the corresponding recess may be provided on the other frame.

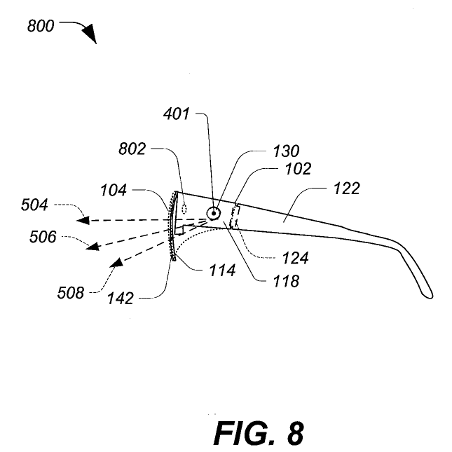

Referring now to FIG. 8, the figure depicts another example of a configuration for classes 800 in accordance with the present invention. In this embodiment of glasses, the point of magnetic attachment is separate and spaced from the pivot location. Specifically the pivot location will still be located at 401, and may be formed by a post and recess structure, similar to those described earlier herein, except that no magnetic element need be present. Alternatively, any suitable structure for providing a pivot point, such as a screw, rivet or similar element could be used. As shown here, the magnet 802 has been moved radially outwardly from the pivot location, preferably, as depicted, toward the lenses, relative to the pivot point. This configuration offers the advantage of placing the point of magnetic attachment in a relatively outward position along the lever arm extending between the pivot point and the lenses within the second frame member, thereby maximizing the holding force exerted. As will be readily understood by those skilled in the art having the benefit of the preceding disclosure, the magnetic coupling may be attached in a similar manner to those previously described, with the exception that no provision needs to be made for a pin/recess engagement, since the pivot location is placed away from the magnet, as shown.

In general, it should be understood with respect to the above-discussion that the numeric terms first, second, third, and fourth are not intended to imply any particular ordering or significance other than to identify one element from another element. Further, it should be understood that the recessed portions and the posts may be interchanged. In particular, the second frame member may include posts or recesses, depending on the implementation. Further, the magnetic coupling may include one or more post/recess pairs. In a particular instance, the magnetic coupling may be used to adjust an angle of the second frame member to take advantage of pre-defined optical regions of the second lens.

Additionally, though the above-examples have illustrated a first frame member with a first lens and a second frame member with a second lens, the first lens may be omitted in certain instances. Alternatively, the first and third lenses or the second and fourth lenses may provide first and second two-piece composite lens systems that have neutral focal power.

In conjunction with the eyeglass devices and methods disclosed above with respect to FIGS. 1-7, an eyeglass device is disclosed that includes a first frame member and a second frame member that is coupled to the first frame member via a magnetic coupling, which defines a pivot axis about which the second frame member can be pivoted relative to the first frame member to alter an optical parameter. In a particular embodiment, by adjusting the second frame member relative to the first frame member, a first focal power of a first lens of the first frame member can be combined with a second focal power of a second lens of the second frame member to produce a two-piece composite lens system having a desired focal power. Further, the first frame member and the second frame member may be associated with one another, at least in part, through one or more magnets. The association may sometimes be referred to as a magnetic coupling, which may define a pivot axis about which the second frame member is adapted to pivot relative to the first frame member.

In an example, the techniques described above can be applied to greatly reduce the cost of providing eyeglasses. For example, using composite lens systems, an inventory stocks of lenses needed to meet the needs of various patients may be reduced. In particular, the number of lenses needed to meet patient's needs for focus and astigmatism correction can be reduced by combining focal powers of different lenses to meet the patient's vision correction needs.

For example, a manufacturer can provide a relatively small number of certain, coarsely spaced, focus powers through lens pairs that are maintained in stock. A particular eye-care facility may choose to stock about 10 to 20 different focus power lens pairs. Fine-tuning can be accomplished by displacing the two lenses in the lens pair to meet the needs of the specific patient. The lens pair can then be cut and placed into the frames after the displacement is made. Further, by stamping the frames from a sheet metal or by forming them of a deformable plastic material, the frame production can be relatively inexpensive and the eyeglasses may be assembled inexpensively as well, which can translate into cost savings for the eye-care facility and for the patient.

Many modifications and variations may be made to the techniques and structures described and illustrated herein without departing from the scope of the present invention. For example, as referenced above many types of variations might be implemented with respect to the magnetic coupling. For example, the first frame member may include a recess and the second frame member may include a post adapted to associate with the recess. In another embodiment, the first frame member may include a post and the second frame member may include a recess. In yet another embodiment, one or both of the first and second frame members may be provided with a magnet and/or a corresponding metal material or a magnet of opposite polarity to selectively associate the first and second frame members. In an embodiment, the first and second frame members may be associated via a magnetic coupling that does not include either a post or a recess, but where first and second magnets are provided on the first and second frame members and where the magnets have opposite polarities to attract one another to provide the magnetic coupling. As another example of a modification to the described configurations, one or more lenses might have a rigid or flexible lens component affixed to an inner surface of a provided fixed position lens. As one example, the fixed position lens might be provided to provide a base distance correction, but a prescription flexible lens component might be secured to the inner surface to provide (as one example) extreme close-up correction.

Accordingly, the specification and drawings are to be regarded in an illustrative rather than a restrictive sense and the present specification must be understood to provide examples to illustrate the present inventive concepts and to enable others to make and use those inventive concepts.

What is claimed is:

1. An eyeglass device, comprising:
a first frame member configured to hold a first lens and including a first end portion adapted to couple to a first temple;
a second frame member configured to hold a second lens, the first and second frame members pivotally coupled to one another; and
at least one of the first and second frame members comprising a magnetic component, and the other of the first and second frame members comprising a magnetically attractable component, wherein the magnetic component and the magnetically attractable component form a magnetic coupling between the first and second frame members.

2. The eyeglass device of claim 1, wherein the first lens and the second lens cooperate to provide a two-piece composite lens system having a focal power that is adjustable as the second lens is translated relative to the first lens.

3. The eyeglass device of claim 2, wherein the first and second frame members are pivotably attached at a pivot point, and wherein the magnetic coupling is located at the pivot point.

4. The eyeglass device of claim 1, wherein the wherein the first and second frame members are pivotably attached at a pivot point, and wherein the magnetic coupling is located radially outwardly from the pivot point.

5. The eyeglass device of claim 3, wherein the magnetic coupling comprises:
a recess formed on the first frame member; and
a post formed on the second frame member, the post sized to fit within the recess.

6. The eyeglass device of claim 4, wherein the magnetic coupling comprises:
a post formed on the first end portion; and
a recess formed on the second end portion and sized to receive the post.

7. The eyeglass device of claim 1, wherein the second frame member comprises:
a rim; and
an end portion including a slot continuous with the at least one rim, wherein the slot is deformable to alter a shape of the rim to secure the second corrective lens.

8. The eyeglass device of claim 7, wherein the slot extends longitudinally away from the rim and is deformable by a compressive force applied to the end portion in a direction that is substantially perpendicular to a longitudinal direction of the slot.

9. The eyeglass device of claim 7, wherein the slot includes a ridge configured to interact with a tool to assist a user in expanding the slot.

10. An eyeglass device, comprising
a first frame member;
first and second lenses supported by the first frame member;
a second frame member;
third and fourth lenses supported by the second frame member;
a pivot coupling attaching the first frame member to the second frame member where the second frame member is translatable through a generally arcuate path relative to the first frame member; and
a magnetic coupling configured to secure the first and second frame members in a desired relative location.

11. The eyeglass device of claim 10, wherein the magnetic coupling is located at essentially the same location as the pivot coupling.

12. The eyeglass device of claim 10, wherein the magnetic coupling is located in spaced relation to the pivot coupling.

13. An eyeglass device, comprising:
a first frame member comprising:
a first frame member front including at least one first lens rim to secure a first optical lens;
a first end portion coupled to the first frame member front;
a second end portion coupled to the first frame member front;
a second frame member comprising:
a second frame member front including at least one second lens rim to secure a second optical lens;
a third end portion coupled to the second frame member front; and
a magnetic coupling between the first frame member and the second frame member.

14. The eyeglass device of claim 13, wherein the second frame member is adapted to rotate about an axis relative to the first frame member, the axis co-located with the magnetic coupling.

15. The eyeglass device of claim 14, wherein the relative positioning between the second frame member and the first frame member is selectively adjustable to translate the second lens relative to the first lens to adjust a focal power parameter associated with the two lenses.

16. The eyeglass device of claim 13, wherein the second frame member further comprises a fourth end portion coupled to the second frame member front, and wherein the fourth end portion is adapted to couple to the second end portion.

17. The eyeglass device of claim 16, wherein the fourth end portion and the second end portion are coupled via a second magnetic coupling.

18. The eyeglass device of claim 13, wherein the first end portion comprises a recessed area, wherein the third end portion comprises a post sized to fit the recessed area, and wherein at least one of the post and the recessed area includes a magnet.

19. The eyeglass device of claim 13, wherein the first end portion comprises a post, wherein the third end portion comprises a recess sized to receive the post, and wherein at least one of the post and the recessed area includes a magnet.

20. The eyeglass device of claim 13, further comprising:
a first temple;
a first hinge coupling the first temple to the first end portion;
a second temple; and
a second hinge coupling the second temple to the second end portion.

21. The eyeglass device of claim 13, wherein the third end portion includes a slot that is compressible to adjust a dimension of the at least one second lens rim to secure the at least one second optical lens within the second frame member.

22. An eyeglass device, comprising:
a first frame member including a first frame member front configured to hold at least a first lens, and including a first end portion; and
a second frame member including a second frame member front configured to hold at least a second lens, and including a second end portion;
a magnetic coupling arranged to provide at least some attachment between the first frame member and the second frame member;
wherein the second frame member is adjustable relative to the first frame member to selectively translate the at least one second lens relative to the at least one first lens to adjust a focal power of a two-piece composite lens system including the first and second lenses.

23. The eyeglass device of claim 22, wherein the first lens and the second lens are components of a two-piece composite lens system.

24. The eyeglass device of claim 23, wherein the first lens comprises a first corrective lens and a first neutral lens, and wherein the at least one second lens comprises a second corrective lens and a second neutral lens, wherein the second frame member is adjustable relative to the first frame member to adjust a first focal power of a first two-piece composite lens formed by the first and second corrective lenses, and wherein a second focal power a second two-piece composite lens formed by the first and second neutral lenses remains substantially unchanged.

25. The eyeglass device of claim 22, wherein the second end portion includes at least one of a post and a recess, wherein the first end portion comprises a corresponding feature sized to fit the at least one of the post and the recess.

26. The eyeglass device of claim 25, wherein the second frame member is adapted to pivot about the corresponding feature to selectively translate the at least one second lens relative to the at least one first lens.

27. The eyeglass device of claim 25, wherein at least one of the first end portion and the second end portion includes a magnet.

28. An eyeglass device, comprising
a first frame member comprising a pair of nose pieces;
a second frame member;
first and second lenses supported by the second frame member; and
a pivot coupling attaching the first frame member to the second frame member, and wherein the second frame member is translatable through a generally arcuate path relative to the first frame member.

29. The eyeglass device of claim 28, wherein each of the first and second lenses is selected from the group consisting essentially of bifocal, trifocal, multifocal and progressive addition type lenses.

30. The eyeglass device of claim 28, including a magnetic coupling configured to secure the first and second frame members in a desired relative location.
